(19) United States
(12) Patent Application Publication
(10) Pub. No.: US 2026/0196701 A1
(43) Pub. Date: Jul. 9, 2026

(54) ELECTROLYTE INJECTION METHOD AND ELECTROLYTE INJECTION APPARATUS

(71) Applicant: SK On Co., Ltd., Seoul (KR)

(72) Inventor: Yun Sung JANG, Daejeon (KR)

(21) Appl. No.: 19/440,653

(22) Filed: Jan. 6, 2026

(30) Foreign Application Priority Data
Jan. 7, 2025 (KR) 10-2025-0002298

(51) Int. Cl. H01M 50/609

(52) U.S. Cl. CPC H01M 50/609

(57) ABSTRACT

Proposed are an electrolyte injection method and an electrolyte injection apparatus. The method includes an electrolyte supply process for supplying an electrolyte, an electrolyte storage process in which the electrolyte supplied during the electrolyte supply process is stored in an electrolyte tank, a primary electrolyte collection process in which an electrolyte discarded during the electrolyte storage process is stored in a waste solution collection tank, an electrolyte injection process in which the electrolyte stored in the electrolyte tank is supplied to an electrolyte injection part, an electrolyte injection stopping process in which the electrolyte injection process is stopped when a capacity of the electrolyte stored in the waste solution collection tank is equal to or more than a predetermined capacity, and an electrolyte recycling process in which the electrolyte stored in the waste solution collection tank is supplied to the electrolyte injection part after the electrolyte injection stopping process.

### CROSS REFERENCE TO RELATED APPLICATION

The present application claims priority to Korean Patent Application No. 10-2025-0002298, filed January 07, 2025, the entire contents of which are incorporated herein for all purposes by this reference.

### BACKGROUND

### Technical Field

The present disclosure relates to an electrolyte injection method and an electrolyte injection apparatus.

### Description of the Related Art

In recent years, as there has been increasing demand for portable electronic products such as laptop computers, video cameras, and mobile phones and the development of electric vehicles, batteries for energy storage, robots, and satellites has begun in earnest, a lot of research has been conducted on secondary batteries that are used as drive power sources for these products.

Examples of such secondary batteries include nickel-cadmium batteries, nickel-hydrogen batteries, nickel-zinc batteries, and lithium secondary batteries.

Among them, the lithium secondary batteries are widely used in the field of high-tech electronic devices because they have advantages, for example, exhibiting few memory effects in comparison with nickel-based secondary batteries and thus being freely charged and discharged, and having very low self-discharge rate, high operating voltage, and high energy density per unit weight.

Generally, the lithium secondary batteries are configured such that a stack or wound structure of an electrode assembly formed of a positive electrode, a negative electrode, and a separator interposed between the positive electrode and the negative electrode is embedded in a metal can or a casing of a laminate sheet into which an electrolyte solution is then injected or poured.

### Document of Related Art

### (Patent Document 1) JP 2018-106816 A

### SUMMARY

According to an aspect of the present disclosure, an electrolyte injection method and an electrolyte injection apparatus that are capable of recycling an electrolyte that is discarded in a battery manufacturing process may be provided.

According to another aspect of the present disclosure, an electrolyte injection method and an electrolyte injection apparatus that are capable of being widely applied in the fields of green technology such as electric vehicles, battery charging stations, and other solar photovoltaic power generation using batteries, wind power generation, and so on may be provided.

According to an embodiment of the present disclosure, there is provided an electrolyte injection method including: an electrolyte supply process in which an electrolyte is supplied to an electrolyte tank; an electrolyte storage process in which the electrolyte supplied during the electrolyte supply process is stored in the electrolyte tank; a primary electrolyte collection process in which an electrolyte discarded during the electrolyte storage process is moved and stored in a waste solution collection tank; an electrolyte injection process in which the electrolyte stored in the electrolyte tank is moved and supplied to an electrolyte injection part; an electrolyte injection stopping process in which the electrolyte injection process is stopped when a capacity of the electrolyte stored in the waste solution collection tank is equal to or more than a predetermined capacity; and an electrolyte recycling process in which the electrolyte stored in the waste solution collection tank is moved and supplied to the electrolyte injection part after the electrolyte injection stopping process.

Here, the electrolyte storage process may include: a primary electrolyte storage process in which the electrolyte supplied during the electrolyte supply process is stored in a first electrolyte tank included in the electrolyte tank; and a secondary electrolyte storage process in which the electrolyte stored in the first electrolyte tank is moved to a second electrolyte tank included in the electrolyte tank and the electrolyte is stored in the second electrolyte tank.

In addition, the primary electrolyte collection process may include: a primary waste solution storage process in which the electrolyte discarded in the primary electrolyte storage process is stored in a first waste solution tank; a secondary waste solution storage process in which the electrolyte discarded in the secondary electrolyte storage process is stored in a second waste solution tank; and a waste solution moving process in which the electrolyte stored in the first waste solution tank and the electrolyte stored in the second waste solution tank are moved to the waste solution collection tank by a waste solution pump.

In addition, the electrolyte supply process may include a process in which an electrolyte supply to the first electrolyte tank is stopped when a capacity of the electrolyte inside the first electrolyte tank is equal to or more than a first set capacity.

In addition, the secondary electrolyte storage process may include a process in which an electrolyte supply to the second electrolyte tank is stopped when a capacity of the electrolyte inside the second electrolyte tank is equal to or more than a second set capacity.

In addition, the electrolyte injection method may further include an electrolyte recycling stopping process in which an electrolyte supply to the electrolyte injection part is stopped when a capacity of the electrolyte inside the waste solution collection tank is less than a fourth set capacity after the electrolyte recycling process.

In addition, the electrolyte injection method may further include a process in which the electrolyte injection method starts from the electrolyte injection process again after the electrolyte recycling stopping process.

In addition, the electrolyte injection method may further include a secondary electrolyte collection process in which the electrolyte discarded during injecting the electrolyte into an object from the electrolyte injection part is stored in the waste solution collection tank after the electrolyte injection process or the electrolyte recycling step.

According to an embodiment of the present disclosure, there is provided an electrolyte injection apparatus including: a supply part configured to supply an electrolyte; a collection part configured to collect an electrolyte discarded from the supply part; and an injection part configured to receive the electrolyte from the supply part or the collection part and to inject the electrolyte into an object.

Here, the supply part may include: a first electrolyte tank configured to primarily store the electrolyte therein; and a second electrolyte tank positioned below the first electrolyte tank, the second electrolyte tank being configured to receive the electrolyte from the first electrolyte tank and to secondarily store the electrolyte therein.

In addition, the supply part may further include a first flow path configured such that the first electrolyte tank and the second electrolyte tank are in fluid communication with each other by the first flow path, and the first flow path may have a bent portion which is configured to change a movement direction of the electrolyte and which is formed in a curved shape.

In addition, the collection part may include: a first waste solution tank in communication with the first electrolyte tank, the first waste solution tank being configured to store a discarded electrolyte generated from the first electrolyte tank therein, and the first waste solution tank having a sealed structure; a second waste solution tank in communication with the second electrolyte tank, the second waste solution tank being configured to store a discarded electrolyte generated from the second electrolyte tank therein, and the second waste solution tank having a sealed structure; a waste solution collection tank in fluid communication with the first waste solution tank and the second waste solution tank, the waste solution collection tank being configured to receive the electrolyte stored in the first waste solution tank and the second waste solution tank and to store the electrolyte therein; and a waste solution pump configured to provide a driving force such that the electrolyte stored in the first waste solution tank and the electrolyte stored in the second waste solution tank are moved to the waste solution collection tank.

In addition, the injection part may include a dummy vent container configured to store the electrolyte discarded during injecting the electrolyte into the object.

In addition, the collection part may be configured to collect the electrolyte from the dummy vent container.

The features and advantages of the present disclosure will be more clearly understood from the following detailed description based on the accompanying drawings.

The terms and words used in the present specification and claims should not be interpreted as being limited to typical meanings and dictionary definitions, but should be interpreted as having meanings and concepts relevant to the technical scope of the present disclosure based on the rule according to which an inventor can appropriately define the concept of the term to describe most appropriately the best method he or she knows for carrying out the present disclosure.

According to an embodiment of the present disclosure, the discarded electrolyte generated during the battery manufacturing process may be recycled.

In addition, the loss of raw materials generated during the battery manufacturing process may be reduced.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a flowchart showing an electrolyte injection method according to an embodiment of the present disclosure;

FIG. 2 is a system view schematically illustrating an electrolyte injection apparatus according to an embodiment of the present disclosure; and

FIG. 3 is a flowchart showing the electrolyte injection method according to another embodiment of the present disclosure.

### DETAILED DESCRIPTION

The terms used in the present disclosure are used to describe an embodiment, and are not intended to limit the present disclosure. Singular expressions include plural expressions unless the context clearly indicates otherwise.

In adding reference numerals to components throughout the drawings, it is to be noted that like or similar reference numerals designate like or similar components even though the components are illustrated in different drawings.

The drawings may be exaggerated or shown schematically for description of an embodiment. In the present document, expressions such as “include”, “may include”, “comprise”, “may comprise” and so on used herein indicate existence of corresponding features (for example, numeric values, functions, operations, or components such as parts), and does not exclude existence of additional features.

The terms “one”, “other”, “another”, “first”, “second”, and so on are used to differentiate one constituent element from another constituent element, and these constituent elements should not be limited by these terms.

Hereinafter, an embodiment of the present disclosure will be described in detail with reference to the accompanying drawings.

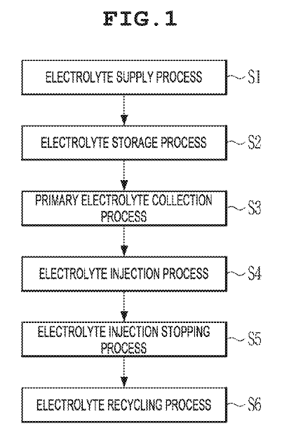

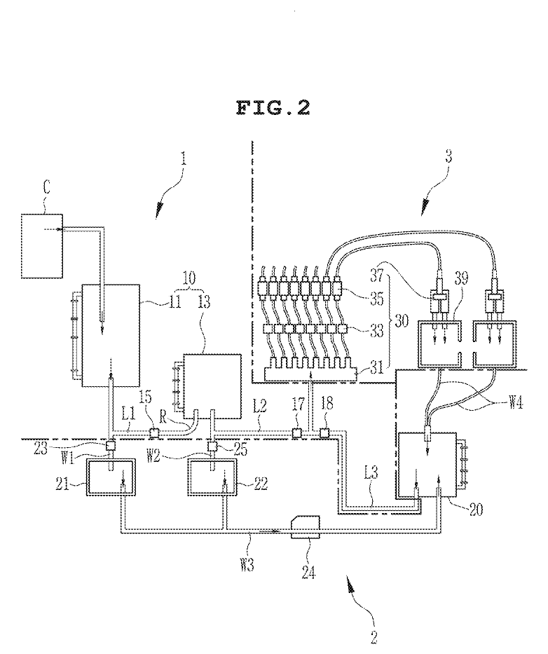

FIG. 1 is a flowchart illustrating an electrolyte injection method according to an embodiment of the present disclosure, and FIG. 2 is a system view illustrating an electrolyte injection apparatus according to an embodiment of the present disclosure.

An electrolyte injection method according to an embodiment of the present disclosure may include an electrolyte supply process S1 in which an electrolyte is supplied to an electrolyte tank, an electrolyte storage process S2 in which the electrolyte supplied during the electrolyte supply process S1 is stored in an electrolyte tank 10, a primary electrolyte collection process S3 in which an electrolyte discarded during the electrolyte storage process S2 is moved and stored in a waste solution collection tank 20, an electrolyte injection process S4 in which the electrolyte stored in the electrolyte tank 10 is moved and supplied to an electrolyte injection part 30, an electrolyte injection stopping process S5 in which the electrolyte injection process S4 is stopped when a capacity of the electrolyte stored in the waste solution collection tank 20 is equal to or more than a predetermined capacity, and an electrolyte recycling process S6 in which the electrolyte stored in the waste solution collection tank 20 is moved and supplied to the electrolyte injection part 30 after the electrolyte injection stopping process S5.

As illustrated in FIG. 1 and FIG. 2, the electrolyte supply process S1 of the electrolyte injection method according to an embodiment of the present disclosure may be a process of supplying an electrolyte for being injected into an object such as a battery including a secondary battery.

As an embodiment, in the electrolyte supply process S1, an electrolyte may be supplied by using an electrolyte central supply device C.

The electrolyte central supply device C may be a facility for transferring, storing, and supplying an electrolyte required for battery production.

Such an electrolyte central supply device C may use a method in which an electrolyte supplied from the outside is transferred in a nitrogen pressing manner so as to distribute the electrolyte to an injection facility as required.

In addition, in the electrolyte supply process S1, the electrolyte may be supplied from the electrolyte central supply device C to the electrolyte tank 10 that includes a first electrolyte tank 11 and a second electrolyte tank 13.

In addition, when a capacity of an electrolyte stored inside the first electrolyte tank 11 is equal to or more than a first set capacity, supplying the electrolyte to the electrolyte tank 10 may be stopped in the electrolyte supply process S1.

For example, the first set capacity may be a capacity in which the first electrolyte tank 11 stores electrolyte at 85% of a total capacity of the first electrolyte tank 11.

The electrolyte storage process S2 may be a process in which the electrolyte supplied in the electrolyte supply process S1 is stored in the electrolyte tank 10.

The electrolyte storage process S2 may include a primary electrolyte storage process in which the electrolyte is primarily stored from an upstream side and a secondary electrolyte storage process in which the electrolyte is secondarily stored from a downstream side.

The primary electrolyte storage process may be a process in which the electrolyte positioned on an upstream side of the electrolyte storage process S2 and supplied from the electrolyte supply process S1 is stored in the first electrolyte tank 11.

The secondary electrolyte storage process may be a process in which the electrolyte positioned on a downstream side of the electrolyte storage process S2 and stored in the first electrolyte tank 11 is moved and stored in the second electrolyte tank 13.

In the secondary electrolyte storage process, when a capacity of the electrolyte inside the second electrolyte tank 13 is equal to or more than a second set capacity, the movement of the electrolyte from the first electrolyte tank 11 to the second electrolyte tank 13 may be stopped.

For example, the second set capacity may be a capacity in which the second electrolyte tank 13 stores electrolyte at 85% of a total capacity of the second electrolyte tank 13.

A first flow path L1 for moving the electrolyte may be positioned between the first electrolyte tank 11 and the second electrolyte tank 13.

In addition, the first electrolyte tank 11 is positioned above the second electrolyte tank 13, so that the electrolyte may be moved from the first electrolyte tank 11 to the second electrolyte tank 13 in a free fall manner due to gravity.

In addition, a first valve 15 may be positioned in the first flow path L1 that is positioned between the first electrolyte tank 11 and the second electrolyte tank 13.

In addition, when the first valve 15 is opened, the movement of the electrolyte from the first electrolyte tank 11 to the second electrolyte tank 13 is allowed. Furthermore, when the first valve 15 is closed, the movement of the electrolyte from the first electrolyte tank 11 to the second electrolyte tank 13 is blocked.

In addition, the first flow path L1 has a bent region to be connected to the second electrolyte tank 13 and the bent region is formed in a curved shape (see FIG. 2), so that a generation of bubbles during moving the electrolyte from the first electrolyte tank 11 to the second electrolyte tank 13 may be minimized.

In addition, in the present disclosure, the curved shape is not limited to the first flow path L1, and the curved shape for minimizing the generation of bubbles may be formed at a bent region formed in a flow path of the electrolyte.

The primary electrolyte collection process S3 may be a process in which the electrolyte discarded in the electrolyte storage process S2 is moved and stored in the waste solution collection tank 20.

In the present disclosure, the discarded electrolyte may be defined as an electrolyte that is filtered out since the electrolyte has bubbles and so on.

The electrolyte discarded in the primary electrolyte collection process S3 may be an electrolyte that is separated and collected by operating a valve connected to the waste solution collection tank 20 within 30 seconds when the electrolyte injection process is restarted while the electrolyte injection process is stopped for at least three days.

The primary electrolyte collection process S3 may include a primary waste solution storage process, a secondary waste solution storage process, and a waste solution moving process.

The primary waste solution storage process may be a process in which the electrolyte (waste solution) discarded in the primary electrolyte storage process is stored in a first waste solution tank 21.

In the primary waste solution storage process, a portion of the electrolyte stored in the first electrolyte tank 11, which is a waste solution portion in which bubbles are generated, may be moved and stored in the first waste solution tank 21.

The first electrolyte tank 11 and the first waste solution tank 21 may be in fluid communication with each other by a first waste solution flow path W1.

In addition, a first waste solution valve 23 may be positioned in the first waste solution flow path W1.

In addition, when the first waste solution valve 23 is opened, the movement of the electrolyte from the first electrolyte tank 11 to the first waste solution tank 21 is allowed. Furthermore, when the first waste solution valve 23 is closed, the movement of the electrolyte from the first electrolyte tank 11 to the first waste solution tank 21 is blocked.

The first waste solution valve 23 may be configured such that the first waste solution valve 23 is opened within 30 seconds and then is automatically closed.

The second waste solution storage process may be a process in which the electrolyte (waste solution) discarded in the secondary electrolyte storage process is stored in a second waste solution tank 22.

In the secondary waste solution storage process, a portion of the electrolyte stored in the second electrolyte tank 13, which is a waste solution portion in which bubbles are generated, may be moved and stored in the second waste solution tank 22.

The second electrolyte tank 13 and the second waste solution tank 22 may be in fluid communication with each other by a second waste solution flow path W2.

In addition, a second waste solution valve 25 may be positioned in the second waste solution flow path W2.

In addition, when the second waste solution valve 25 is opened, the movement of the electrolyte from the second electrolyte tank 13 to the second waste solution tank 22 is allowed. Furthermore, when the second waste solution valve 25 is closed, the movement of the electrolyte from the second electrolyte tank 13 to the second waste solution tank 22 is blocked.

The second waste solution valve 25 may be opened after the first waste solution valve 23 is closed, and may be automatically closed after the second waste solution valve 25 is opened within 30 seconds.

The waste solution moving process may be a process in which a waste solution pump 24 moves the electrolyte stored in the first waste solution tank 21 and the electrolyte stored in the second waste solution tank 22 to the waste solution collection tank 20.

The first waste solution tank 21 and the second waste solution tank 22 may be in communication with the waste solution collection tank 20 through a third waste solution flow path W3.

In addition, the third waste solution flow path W3 may include the waste solution pump 24. The waste solution pump 24 may be operated by an electric motor and so on, and may provide a driving force for moving the electrolyte stored in the first waste solution tank 21 and the second waste solution tank 22 to the waste solution collection tank 20.

The operation of the waste solution pump 24 may be stopped when the capacity of the electrolyte stored inside the waste solution collection tank 20 is equal to or more than 85% of the total capacity of the waste solution collection tank 20.

Since the first waste solution tank 21 and the second waste solution tank 22 are formed in sealed structures, foreign substances may be prevented from being introduced into the electrolyte stored inside the first waste solution tank 21 and the second waste solution tank 22.

The electrolyte injection process S4 may be a process in which the electrolyte stored in the electrolyte tank 10 is moved and supplied to the electrolyte injection part 30.

The electrolyte injection part 30 may include a manifold 31, an injection valve 33, a metering pump 35, and a needle part 37.

The manifold 31 may be in fluid communication with the second electrolyte tank 13 by a second flow path L2, and may provide an inlet passage for the electrolyte.

The injection valve 33 may be in fluid communication with the manifold 31, and may allow or block the movement of the electrolyte that is moved from the manifold 31.

The metering pump 35 may be in fluid communication with the injection valve 33, and may provide a movement driving force of the electrolyte introduced into the manifold 31.

A diaphragm-type metering pump may be used as the metering pump 35 so as to discharge a fixed quantity of the electrolyte.

The needle part 37 may be in fluid communication with the metering pump 35, and may inject the electrolyte into an inner portion of a battery such as a pouch-type secondary battery and so on.

That is, the electrolyte injection part 30 may inject the electrolyte supplied from the electrolyte tank 10 into the inner portion of the battery being manufactured.

The electrolyte injection stopping process S5 may be a process in which the electrolyte injection process S4 is stopped when the electrolyte equal to or more than a predetermined capacity is stored in the waste solution collection tank 20.

The electrolyte stored in the second electrolyte tank 13 may be moved to the manifold 31 through the second flow path L2.

In addition, the second flow path L2 may be provided with a second valve 17.

The second valve 17 may allow or block the movement of the electrolyte that moves through the second flow path L2.

In the electrolyte injection stopping process S5, when the capacity of the electrolyte stored inside the waste solution collection tank 20 is equal to or more than a third set capacity, the second valve 17 is closed so that the movement of the electrolyte is blocked, thereby being capable of stopping the electrolyte injection process S4.

For example, the third set capacity may be a capacity in which the waste solution collection tank 20 stores the electrolyte at 10% of the total capacity of the waste solution collection tank 20.

The electrolyte recycling process S6 may be a process in which the electrolyte stored in the waste solution collection tank 20 after the electrolyte injection stopping process S5 is moved and supplied to the electrolyte injection part 30.

The waste solution collection tank 20 stores the discarded electrolyte therein. Furthermore, when the discarded electrolyte collected in the waste solution collection tank 20 reaches equal to or more than 10% of the total capacity of the waste solution collection tank 20, the discarded electrolyte may be used as the electrolyte capable of being injected into the battery.

In addition, the waste solution collection tank 20 may be in fluid communication with the manifold 31 by a third flow path L3, and the third flow path L3 may include a third valve 18 capable of allowing or blocking the movement of the electrolyte.

The third valve 18 may be closed in the electrolyte injection process S4, thereby being capable of blocking the movement of the electrolyte.

In addition, the third valve 18 is opened in the electrolyte injection stopping process S5, thereby being capable of allowing the movement of the electrolyte.

The electrolyte stored in the waste solution collection tank 20 is introduced into the electrolyte injection part 30 by a driving force of the metering pump 35, so that the waste solution that is the discarded electrolyte may be injected into the inner portion of the battery and the waste solution may be recycled.

In addition, after the electrolyte recycling process S6, an electrolyte recycling stopping process may further be included.

In the electrolyte recycling stopping process, after the electrolyte recycling process S6, when the capacity of the electrolyte stored inside the waste solution collection tank 20 is less than a fourth set capacity, the electrolyte supply from the waste solution collection tank 20 to the electrolyte injection part 30 may be stopped.

For example, the fourth set capacity may be a capacity in which the waste solution collection tank 20 stores the electrolyte at 10% of the total capacity of the waste solution collection tank 20.

In addition, after the electrolyte recycling stopping process, the electrolyte injection process S4 may be performed again.

That is, in the electrolyte recycling stopping process, when the capacity of the electrolyte stored inside the waste solution collection tank 20 is lower than 10% of the total capacity of the waste solution collection tank 20, the third valve 18 may be closed so as to block the movement of the electrolyte.

In addition, when the third valve 18 is closed, the electrolyte injection process S4 is performed again by opening the second valve 17, so that the electrolyte is capable of being moved from the second electrolyte tank 13 to the electrolyte injection part 30.

As such, the second valve 17 and the third valve 18 may be configured such that one of the second valve 17 and the third valve 18 is closed when the other one of the second valve 17 and the third valve 18 is opened.

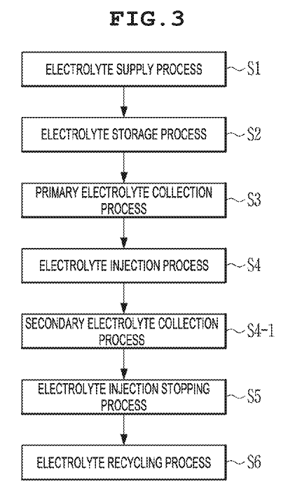

FIG. 3 is a flowchart showing the electrolyte injection method according to another embodiment of the present disclosure.

As illustrated in FIG. 3, the electrolyte injection method according to another embodiment of the present disclosure may further include a secondary electrolyte collection process S4-1 after the electrolyte injection process S4.

The secondary electrolyte collection process S4-1 may be a process in which the electrolyte discarded during injecting the electrolyte into the object from the electrolyte injection part 30 is stored in the waste solution collection tank 20 after the electrolyte injection process S4.

In the secondary electrolyte collection process S4-1, the needle part 37 of the electrolyte injection part 30 may include a dummy vent container 39 on a lower side thereof.

In the secondary electrolyte collection process S4-1, the discarded electrolyte may be an electrolyte discarded by operating the injection valve 33 as a defect occurs in an injection quantity of the electrolyte to the battery into which the electrolyte is injected.

That is, a weight of the battery into which the electrolyte is injected in the electrolyte injection process S4 may be measured in a total inspection manner.

In addition, when the weight of the battery is more than +2% or less than -2% compared to a management standard weight, the electrolyte injection process S4 may be stopped, the electrolyte may be discarded by opening the injection valve 33 within 30 seconds in a state in which the battery is not provided, and the discarded electrolyte may be introduced into the dummy vent container 39.

Here, the management standard weight of the battery may be a battery-specific weight ranging from 105g to 165g for various types of batteries such as a cylindrical-type battery, a pouch-type battery, a prismatic-type battery, and so on.

In addition, the electrolyte discarded in the secondary electrolyte collection process S4-1 may be an electrolyte that is spilled and discarded to the outside during injecting the electrolyte into the battery through the needle part 37.

That is, during injecting the electrolyte into the battery through the needle part 37 in the electrolyte injection process S4, the electrolyte which is not injected into the battery and which is spilled and discarded may be introduced into and stored in the dummy vent container 39.

In addition, in a state in which the electrolyte injection process S4 is stopped and the battery is not provided since the weight of the battery is more than +2% or less than -2% compared to the management standard weight, the electrolyte may be discarded by opening the injection valve 33 within 30 seconds.

When this process occurs more than five times within 10 minutes, the electrolyte injection process S4 is stopped, the injection valve 33 is opened within two minutes without setting the battery, and the electrolyte may be discarded into the dummy vent container 39.

The dummy vent container 39 may be in fluid communication with the waste solution collection tank 20 by a fourth waste solution flow path W4.

In addition, the electrolyte stored in the dummy vent container 39 may be moved to the waste solution collection tank 20 through the fourth waste solution flow path W4 and may be stored in the waste solution collection tank 20.

The dummy vent container 39 is positioned above the waste solution collection tank 20, so that the electrolyte is capable of being moved from the dummy vent container 39 to the waste solution collection tank 20 in the free fall manner.

In addition, as still another embodiment of the present disclosure, the secondary electrolyte collection process may be a process in which the electrolyte discarded during injecting the electrolyte into the battery in the electrolyte recycling process S6 is stored in the waste solution collection tank 20.

Since the process of collecting the discarded electrolyte in the waste solution collection tank 20 is the same as the process described above, the redundant description will be omitted.

Referring to FIG. 2, an electrolyte injection apparatus according to an embodiment of the present disclosure may include a supply part 1 configured to supply an electrolyte, a collection part 2 configured to collect an electrolyte discarded from the supply part 1, and an injection part 3 configured to receive the electrolyte from the supply part 1 or the collection part 2 and to inject the electrolyte into an object.

The supply part 1 may include the electrolyte tank 10, the first flow path L1, the second flow path L2, and the third flow path L3.

The electrolyte tank 10 may include the first electrolyte tank 11 and the second electrolyte tank 13.

The first electrolyte tank 11 may primarily store the electrolyte therein.

The first electrolyte tank 11 may receive the electrolyte from the electrolyte central supply device C that is a facility that transfers, stores, and supplies the electrolyte required for battery production, and may store the electrolyte therein.

In addition, the second electrolyte tank 13 may be positioned below the first electrolyte tank 11, and may receive the electrolyte from the first electrolyte tank 11 and may secondarily store the electrolyte therein.

The second electrolyte tank 13 may receive the electrolyte from the first electrolyte tank 11 through the first flow path L1.

The second electrolyte tank 13 may be formed such that a size of the second electrolyte tank 13 is smaller than a size of the first electrolyte tank 11, and may be positioned below the first electrolyte tank 11.

Therefore, the second electrolyte tank 13 may receive the electrolyte from the first electrolyte tank 11 in the free fall manner due to gravity.

The first electrolyte tank 11 and the second electrolyte tank 13 may be in fluid communication with each other by the first flow path L1.

In addition, the first flow path L1 may be provided with the first valve 15.

In addition, when the first valve 15 is opened, the movement of the electrolyte from the first electrolyte tank 11 to the second electrolyte tank 13 is allowed. Furthermore, when the first valve 15 is closed, the movement of the electrolyte from the first electrolyte tank 11 to the second electrolyte tank 13 is blocked.

In addition, a bent portion of the first flow path L1 changing a movement direction of the electrolyte may be formed in the curved shape.

Therefore, the first flow path L1 may minimize bubbles that may be generated during the movement process of the electrolyte.

However, the bent portion is not limited to the first flow path L1, and may be applied to the second flow path L2, the third flow path L3, the first waste solution flow path W1, the second waste solution flow path W2, the third waste solution flow path W3, and the fourth waste solution flow path W4 that provide a flow path of fluid.

The second electrolyte tank 13 and the manifold 31 may be in fluid communication with each other by the second flow path L2.

In addition, the second flow path L2 may be provided with the second valve 17.

The second valve 17 may allow or block the movement of the electrolyte that moves through the second flow path L2.

The waste solution collection tank 20 and the manifold 31 may be in fluid communication with each other by the third flow path L3.

The third flow path L3 may be provided with the third valve 18.

The third valve 18 may allow or block the movement of the electrolyte that moves through the third flow path L3.

The collection part 2 may include the waste solution collection tank 20, the first waste solution tank 21, the second waste solution tank 22, the waste solution pump 24, the first waste solution flow path W1, the second waste solution flow path W2, the third waste solution flow path W3, and the fourth waste solution flow path W4.

The first waste solution tank 21 is in communication with the first electrolyte tank 11, and may store the discarded electrolyte generated from the first electrolyte tank 11 therein.

In addition, since the first waste solution tank 21 is formed in the sealed structure, foreign substances are prevented from being introduced into the first waste solution tank 21, thereby being capable of preventing a contamination of the electrolyte.

The first waste solution tank 21 may collect the discarded electrolyte generated from the first electrolyte tank 11 therein.

The first waste solution tank 21 and the first electrolyte tank 11 may be in fluid communication with each other by the first waste solution flow path W1.

In addition, the first waste solution flow path W1 may be provided with the first waste solution valve 23.

The first waste solution valve 23 may allow or block the movement of the electrolyte from the first electrolyte tank 11 to the first waste solution tank 21.

That is, when the first waste solution valve 23 is opened, the movement of the electrolyte from the first electrolyte tank 11 to the first waste solution tank 21 is allowed. Furthermore, when the first waste solution valve 23 is closed, the movement of the electrolyte from the first electrolyte tank 11 to the first waste solution tank 21 is blocked.

The second waste solution tank 22 is in communication with the second electrolyte tank 13, and may store the discarded electrolyte generated from the second electrolyte tank 13 therein.

In addition, since the second waste solution tank 22 is formed in the sealed structure, foreign substances are prevented from being introduced into the second waste solution tank 22, thereby being capable of preventing a contamination of the electrolyte.

The second waste solution tank 22 may collect the discarded electrolyte generated from the second electrolyte tank 13 therein.

The second waste solution tank 22 and the second electrolyte tank 13 may be in fluid communication with each other by the second waste solution flow path W2.

In addition, the second waste solution flow path W2 may be provided with the second waste solution valve 25. The second waste solution valve 25 may allow or block the movement of the electrolyte from the second electrolyte tank 13 to the second waste solution tank 22.

That is, when the second waste solution valve 25 is opened, the movement of the electrolyte from the second electrolyte tank 13 to the second waste solution tank 22 is allowed. Furthermore, when the second waste solution valve 25 is closed, the movement of the electrolyte from the second electrolyte tank 13 to the second waste solution tank 22 is blocked.

The waste solution collection tank 20 is in fluid communication with the first waste solution tank 21 and the second waste solution tank 22, and may receive the electrolyte stored in the first waste solution tank 21 and the second waste solution tank 22 and may store the received electrolyte therein.

The first waste solution tank 21 and the second waste solution tank 22 may be in fluid communication with the waste solution collection tank 20 by the third waste solution flow path W3.

The third waste solution flow path W3 may be provided with the waste solution pump 24.

The waste solution pump 24 may provide a driving force such that the electrolyte stored in the first waste solution tank 21 and the second waste solution tank 22 is moved to the waste solution collection tank 20.

The waste solution pump 24 may be operated by an electric motor and so on.

The waste solution pump 24 may be stopped when the capacity of the electrolyte stored inside the waste solution collection tank 20 exceeds 85% of the total capacity of the waste solution collection tank 20.

The dummy vent container 39 and the waste solution collection tank 20 may be in fluid communication with each other by the fourth waste solution flow path W4.

The injection part 3 may inject the electrolyte into an inner portion of the object such as a battery. The injection part 3 may include the electrolyte injection part 30 and the dummy vent container 39.

The electrolyte injection part 30 may inject the electrolyte into the object.

The electrolyte injection part 30 may include the manifold 31, the injection valve 33, the metering pump 35, and the needle part 37.

The manifold 31 may provide an inlet passage for the electrolyte.

The injection valve 33 may be in fluid communication with the manifold 31, and may allow or block the movement of the electrolyte that is moved from the manifold 31.

The metering pump 35 is connected to the injection valve 33, and may provide a movement driving force of the electrolyte introduced into the manifold 31.

A diaphragm-type metering pump may be used as the metering pump 35 so as to discharge a fixed quantity of the electrolyte.

The needle part 37 is in fluid communication with the metering pump 35, and may inject the electrolyte into the inner portion of the object such as the battery.

The dummy vent container 39 may store the electrolyte discarded during injecting the electrolyte into the object.

The dummy vent container 39 may collect the electrolyte discarded during injecting the electrolyte into the battery, and may store the discarded electrolyte therein.

The dummy vent container 39 may be provided below the needle part 37 of the electrolyte injection part 30.

In addition, the electrolyte stored in the dummy vent container 39 may be moved to the waste solution collection tank 20 through the fourth waste solution flow path W4, and may be stored in the waste solution collection tank 20.

The dummy vent container 39 is positioned above the waste solution collection tank 20, so that the electrolyte is capable of being moved from the dummy vent container 39 to the waste solution collection tank 20 in the free fall manner.

That is, the collection part 2 may collect the electrolyte from the dummy vent container 39 provided in the injection part 3.

The present disclosure has been described in detail through specific embodiments. The embodiment is proposed to more concretely describe the present disclosure. However, the embodiment is only given for illustrating the present disclosure and those skilled in the related art will obviously understand that various alterations and modifications are possible within the scope and spirit of the present disclosure. Such alterations and modifications are duly included in the appended claims.

What is claimed is:

1. An electrolyte injection method comprising:
an electrolyte supply process in which an electrolyte is supplied to an electrolyte tank;
an electrolyte storage process in which the electrolyte supplied during the electrolyte supply process is stored in the electrolyte tank;
a primary electrolyte collection process in which an electrolyte discarded during the electrolyte storage process is moved and stored in a waste solution collection tank;
an electrolyte injection process in which the electrolyte stored in the electrolyte tank is moved and supplied to an electrolyte injection part;
an electrolyte injection stopping process in which the electrolyte injection process is stopped when a capacity of the electrolyte stored in the waste solution collection tank is equal to or more than a predetermined capacity; and
an electrolyte recycling process in which the electrolyte stored in the waste solution collection tank is moved and supplied to the electrolyte injection part after the electrolyte injection stopping process.

2. The electrolyte injection method of claim 1, wherein the electrolyte storage process comprises:
a primary electrolyte storage process in which the electrolyte supplied during the electrolyte supply process is stored in a first electrolyte tank included in the electrolyte tank; and
a secondary electrolyte storage process in which the electrolyte stored in the first electrolyte tank is moved to a second electrolyte tank included in the electrolyte tank and the electrolyte is stored in the second electrolyte tank.

3. The electrolyte injection method of claim 2, wherein the primary electrolyte collection process comprises:
a primary waste solution storage process in which the electrolyte discarded in the primary electrolyte storage process is stored in a first waste solution tank;
a secondary waste solution storage process in which the electrolyte discarded in the secondary electrolyte storage process is stored in a second waste solution tank; and
a waste solution moving process in which the electrolyte stored in the first waste solution tank and the electrolyte stored in the second waste solution tank are moved to the waste solution collection tank by a waste solution pump.

4. The electrolyte injection method of claim 2, wherein the electrolyte supply process comprises a process in which an electrolyte supply to the first electrolyte tank is stopped when a capacity of the electrolyte inside the first electrolyte tank is equal to or more than a first set capacity.

5. The electrolyte injection method of claim 2, wherein the secondary electrolyte storage process comprises a process in which an electrolyte supply to the second electrolyte tank is stopped when a capacity of the electrolyte inside the second electrolyte tank is equal to or more than a second set capacity.

6. The electrolyte injection method of claim 1, further comprising:
an electrolyte recycling stopping process in which an electrolyte supply to the electrolyte injection part is stopped when a capacity of the electrolyte inside the waste solution collection tank is less than a fourth set capacity after the electrolyte recycling process.

7. The electrolyte injection method of claim 6, further comprising:
a process in which the electrolyte injection method starts from the electrolyte injection process again after the electrolyte recycling stopping process.

8. The electrolyte injection method of claim 1, further comprising:
a secondary electrolyte collection process in which the electrolyte discarded during injecting the electrolyte into an object from the electrolyte injection part is stored in the waste solution collection tank after the electrolyte injection process.

9. An electrolyte injection apparatus comprising:
a supply part configured to supply an electrolyte;
a collection part configured to collect an electrolyte discarded from the supply part; and
an injection part configured to receive the electrolyte from the supply part or the collection part and to inject the electrolyte into an object.

10. The electrolyte injection apparatus of claim 9, wherein the supply part comprises:
a first electrolyte tank configured to primarily store the electrolyte therein; and
a second electrolyte tank positioned below the first electrolyte tank, the second electrolyte tank being configured to receive the electrolyte from the first electrolyte tank and to secondarily store the electrolyte therein.

11. The electrolyte injection apparatus of claim 10, wherein the supply part further comprises:
a first flow path configured such that the first electrolyte tank and the second electrolyte tank are in fluid communication with each other by the first flow path, and
wherein the first flow path has a bent portion which is configured to change a movement direction of the electrolyte and which is formed in a curved shape.

12. The electrolyte injection apparatus of claim 10, wherein the collection part comprises:
a first waste solution tank in communication with the first electrolyte tank, the first waste solution tank being configured to store a discarded electrolyte generated from the first electrolyte tank therein, and the first waste solution tank having a sealed structure;
a second waste solution tank in communication with the second electrolyte tank, the second waste solution tank being configured to store a discarded electrolyte generated from the second electrolyte tank therein, and the second waste solution tank having a sealed structure;
a waste solution collection tank in fluid communication with the first waste solution tank and the second waste solution tank, the waste solution collection tank being configured to receive the electrolyte stored in the first waste solution tank and the second waste solution tank and to store the electrolyte therein; and
a waste solution pump configured to provide a driving force such that the electrolyte stored in the first waste solution tank and the electrolyte stored in the second waste solution tank are moved to the waste solution collection tank.

13. The electrolyte injection apparatus of claim 9, wherein the injection part comprises a dummy vent container configured to store the electrolyte discarded during injecting the electrolyte into the object.

14. The electrolyte injection apparatus of claim 13, wherein the collection part is configured to collect the electrolyte from the dummy vent container.
